(19) United States
(12) Patent Application Publication
(10) Pub. No.: US 2024/0228865 A1
(43) Pub. Date: Jul. 11, 2024

(54) COLLOIDAL GAS APHRON-CONTAINING ACID BASED MATRIX ACIDIZING OR FRACTURE ACIDIZING FLUID, AND METHODS OF STIMULATING HYDROCARBONS IN A SUBTERRANEAN FORMATION THEREWITH

(71) Applicant: UNIQUEM INC., Calgary (CA)

(72) Inventors: Amir A. MIRZAEI, Toronto (CA); Hirbod RAD, Calgary (CA)

(21) Appl. No.: 18/560,268

(22) PCT Filed: May 11, 2021
(86) PCT No.: PCT/CA2021/050655

§ 371 Date: Nov. 17, 2023

(51) Int. Cl. C09K 8/74

(52) U.S. Cl. CPC C09K 8/74; C09K 2208/32

(57) ABSTRACT

Described herein is an acidizing fluid. The acidizing fluid comprises a colloidal gas aphron-containing acid (CGAA) composition. The fluid is typically for use in matrix acidizing or fracture acidizing procedures and may be applied before, during, and/or after perforation. Also described are various methods, including methods of fracking, stimulation, and perforation.

### FIELD

The present invention relates to fracturing. More specifically, the present invention is, in aspects, concerned with acidizing fluids and related compositions and methods.

### BACKGROUND

Colloidal gas aphrons (CGAs), first described by Felix Sebba in his book Foams and Biliquid Foams—Aphrons in 1987, incorporating herein by reference, consist of a system of spherical microbubbles with diameters mostly above 25 μm and classified as kugelschaums (ball foam). They possess some colloidal properties and can be pumped at a uniform rate through pipes and channels, much like liquids. Also, they have high stability due to their very small size and thick surfactant shells. Research work published over the past two decades indicate effective applications of CGAs for clarification of particles and microorganisms, protein separation, gas and nutrient transfer, and pollutant separation from water and soil matrices (Hashim, M. A., Mukhopadhyay, S., Gupta, B. S. and Sahu, J. N. (2012), Application of colloidal gas aphrons for pollution remediation. J. Chem. Technol. Biotechnol., 87: 305-324, incorporating herein by reference).

In the oil & gas industry, stimulation with an acid is performed on a well to increase or restore production. In some instances, a well initially exhibits low permeability, and stimulation is employed to commence production from the reservoir. In other instances, stimulation or remediation is used to further encourage permeability and flow from an already existing well that has become under-productive due to scaling issues or formation depletion. Acids are also used in acidizing, for example, but rapid reactivity of the acid with the formation remains to be a problem.

U.S. Pat. No. 9,664,018 describes a method of hydraulically fracturing a subterranean formation. The method comprises generating a primary fracture using a fracturing fluid. The method further comprises extending the primary fracture and/or creating micro fractures about the primary fracture by initiating a chemical reaction such as an exothermic reaction at about the primary fracture. In one embodiment, the fracturing fluid is used to convey one of the reactive components participating in the chemical reaction.

U.S. Pat. No. 10,590,326 describes an aqueous fluid containing a gas-generating compound such as an azo compound, a hydrazide compound, or a semicarbazide compound. The aqueous fluid may also contain an amine compound, an oxidizer, or viscosifier, and a foaming surfactant. The aqueous composition may be storable at pH of less than about 5 without any appreciable gas generation, and may be activated to produce gas when mixed with a wellbore fluid for use in downhole applications.

U.S. Pat. No. 10,626,321 describes compositions, systems, and methods for generating heat and/or gas, for example, to create and/or enhance microfractures in low-permeability formations. In certain embodiments, the methods comprise: providing a treatment fluid that comprises a base fluid and a plurality of microbubbles, wherein the microbubbles each comprise at least an outer shell and a heat- and/or gas-generating chemical within the shell, and have a diameter of about 100 microns or less; and introducing the treatment fluid into at least a portion of a subterranean formation. In some embodiments, the microbubbles may enter one or more microfractures in the subterranean formation and release the heat- and/or gas-generating chemical therein.

### BRIEF DESCRIPTION OF THE DRAWINGS

FIG. 1 shows a representation of the typical shape of colloidal gas aphrons in solution as described herein.

FIG. 2 shows a representation of a high-speed rotating disk generator as described herein.

### SUMMARY

In accordance with an aspect, there is provided an acidizing fluid, the fluid comprising a colloidal gas aphron-containing acid (CGAA) composition.

In an aspect, the acidizing fluid is capable of controlling a rate of reaction between the acid in the colloidal gas aphron-containing acid (CGAA) composition and a hydrocarbon-bearing formation.

In an aspect, the rate of the reaction is reduced.

In an aspect, the rate of the reaction is reduced such that, when the acidizing fluid is applied to the hydrocarbon-bearing formation, the acid is able to penetrate deeper into the formation as compared to an acidizing fluid that does not contain the colloidal gas aphron-containing acid (CGAA) composition.

In an aspect, the acidizing fluid is for placement at or above a perforation area.

In an aspect, the acidizing fluid is for use during or prior to a step of perforating a wellbore in the hydrocarbon-bearing formation.

In an aspect, the acidizing fluid is for matrix acidizing or fracture acidizing.

In an aspect, the acidizing fluid further comprises a corrosion inhibitor adapted to prevent damaging corrosion to a tool, wire-line, and casing during a period of exposure with said fluid.

In an aspect, the tool is a perforating gun.

In an aspect, the acid comprises a mineral acid, an organic acid, a modified acid, a synthetic acid, or a combination thereof.

In an aspect, the acid comprises HCl, methanesulphonic acid, toluenesulfonic acid, sulfamic acid, HCl:amino acid, HCl:alkanolamine, or a combination thereof.

In an aspect, the amino acid comprises lysine, lysine monohydrochloride, alanine, asparagine, aspartic acid, cysteine, glutamic acid, histidine, leucine, methionine, proline, serine, threonine, valine, or a combination thereof.

In an aspect, the alkanolamine comprises monoethanolamine, diethanolamine, triethanolamine, or a combination thereof.

In an aspect, the acidizing fluid comprises from about 0.001% to about 50% by volume colloidal gas aphrons (CGAs), such as from about 0.01% to about 10% by volume CGAs, such as less than about 10% by volume CGAs, such as less than about 1% by volume CGAs, such as from about 0.01% to about 30% by volume CGAs, such as from about 0.1% to about 10% by volume CGAs, such as from about 0.5% to about 5% by volume CGAs.

In an aspect, the CGAA composition further comprises a surfactant.

In an aspect, the surfactant comprises a non-ionic surfactant, an amphoteric surfactant, a cationic surfactant, an anionic surfactants, a polymeric surfactant, or a combination thereof.

In an aspect, the surfactant comprises polyalkylene glycol, alcohol ethoxylate, sulaine, betain, sulfonate, cetyltriammonium chloride or bromide, benzalkonium chloride or bromide, cetrimonium chloride or bromide, diphenyloxide disulfonic acid, lauryl ether sulfates, fatty alcohol ethoxylate, alkylphenol ethoxylate, ethoxylated nonylphenol, ethoxylated octylphenol, cocamidopropyl betain, cocoamidopropyl hydroxysultaine, or a combination thereof.

In an aspect, the surfactant comprises a Gemini anionic surfactant.

In an aspect, the gas in the CGAA composition comprises air, oxygen, nitrogen, argon, carbon dioxide, an organic gas, or a combination thereof.

In an aspect, the acid in the CGAA composition is used at a concentration of from about 1% to about 37% hydrochloric acid or equivalent hydrochloric acid concentration, in the case of hydrochloric acid donating or releasing organic or inorganic salts or adducts of hydrochloric acid, such as from about 7.5% to about 28% hydrochloric acid or equivalent hydrochloric acid concentration, such as about 15% hydrochloric acid or equivalent hydrochloric acid concentration.

In an aspect, the acidizing fluid further comprises an acid corrosion inhibitor or acid cleaning additive, such as iron-control additives, anti-sludge additives, surface tension reduction additives, mutual solvents, non-emulsifying additives, visco-elastic surfactant additives, solvents and solvent emulsifying additives, or combinations thereof.

In an aspect, the acid corrosion inhibitor comprises propargyl alcohol, amines, alkylamines, ethoxylated amines, cinnamaldehyde, or combinations thereof.

In an aspect, the colloidal gas aphrons comprise an average diameter of up to about 200 μm, such as from about 25 μm to about 200 μm.

In an aspect, the acidizing fluid is for use in a perforation operation that is performed underbalanced.

In an aspect, the acidizing fluid is for use in a perforation operation that is performed overbalanced.

In an aspect, the colloidal gas aphrons are generated at the surface through chemical reactions.

In an aspect, the colloidal gas aphrons are generated downhole through chemical reactions.

In an aspect, the colloidal gas aphrons are generated downhole through gas injection.

In accordance with an aspect, there is provided a method for increasing the penetration depth of an acid into a wellbore in a hydrocarbon-bearing formation, the method comprising applying the acidizing fluid described herein to the wellbore.

In accordance with an aspect, there is provided a method for simultaneously injecting gas and acid into a wellbore in a hydrocarbon-containing formation, the method comprising injecting the acidizing fluid described herein to the wellbore.

In accordance with an aspect, there is provided a method for the fracking or stimulation of a hydrocarbon-bearing formation, the method comprising:
inserting a plug in a wellbore at a predetermined location, said wellbore in need of stimulation and comprising a casing;
inserting a perforating tool and a matrix acidizing or fracture acidizing colloidal gas aphron-containing acidic (CGAA) composition into the wellbore; wherein said CGAA composition is in direct contact with both said tool and casing;
positioning the tool within the CGAA composition near said predetermined location;
perforating the wellbore with the tool thereby creating a perforated area and acid soluble debris;
allowing the CGAA composition to come into contact with the perforated area and acid soluble debris for a predetermined period of time sufficient to prepare the formation for fracking or stimulation;
controlling a rate of reaction between the hydrocarbon-bearing formation and an acid in the colloidal gas aphron-containing acidic (CGAA) composition for a period of time;
removing the tool from the wellbore; and
initiating the fracking or stimulation of the perforated area using a stimulation fluid.

In an aspect, the CGAA composition further comprises a corrosion inhibitor adapted to prevent damaging corrosion to a tool, wire-line, and casing during a period of exposure with said fluid.

In an aspect, the method is suitable for increasing acid penetration depth in the wellbore in the hydrocarbon-bearing formation in need of stimulation, the reaction rate of the acid with the hydrocarbon-bearing formation is controlled such that the acid can penetrate further into the wellbore as compared to a matrix acidizing or fracture acidizing composition that does not contain the CGAA composition.

In an aspect, the reaction rate is reduced such that the acid is available to penetrate deeper into the wellbore.

In an aspect, the acid causes increased breakdown and increased permeability of the hydrocarbon-bearing formation.

In an aspect, the step of applying the acidizing fluid to the wellbore is before, during, or after the step of perforating the wellbore.

In an aspect, the step of applying the acidizing fluid to the wellbore is before, or during the step of perforating the wellbore.

In an aspect, the tool is a perforating gun.

In an aspect, the acid comprises a mineral acid, an organic acid, a modified acid, a synthetic acid, or a combination thereof.

In an aspect, the acid comprises HCl, methanesulphonic acid, toluenesulfonic acid, sulfamic acid, HCl:amino acid, HCl:alkanolamine, or a combination thereof.

In an aspect, the amino acid comprises lysine, lysine monohydrochloride, alanine, asparagine, aspartic acid, cysteine, glutamic acid, histidine, leucine, methionine, proline, serine, threonine, valine, or a combination thereof.

In an aspect, the alkanolamine comprises monoethanolamine, diethanolamine, triethanolamine, or a combination thereof.

In an aspect, the acidizing fluid comprises from about 0.001% to about 50% by volume colloidal gas aphrons (CGAs), such as from about 0.01% to about 10% by volume CGAs, such as less than about 10% by volume CGAs, such as less than about 1% by volume CGAs, such as from about 0.01% to about 30% by volume CGAs, such as from about 0.1% to about 10% by volume CGAs, such as from about 0.5% to about 5% by volume CGAs.

In an aspect, the surfactant comprises a non-ionic surfactant, an amphoteric surfactant, a cationic surfactant, an anionic surfactants, a polymeric surfactant, or a combination thereof.

In an aspect, the surfactant comprises polyalkylene glycol, alcohol ethoxylate, sulaine, betain, sulfonate, cetyltriammonium chloride or bromide, benzalkonium chloride or bromide, cetrimonium chloride or bromide, diphenyloxide disulfonic acid, lauryl ether sulfates, fatty alcohol ethoxylate, alkylphenol ethoxylate, ethoxylated nonylphenol, ethoxylated octylphenol, cocamidopropyl betain, cocoamidopropyl hydroxysultaine, or a combination thereof.

In an aspect, the surfactant comprises a Gemini surfactant.

In an aspect, the gas in the CGAA composition comprises air, oxygen, nitrogen, argon, carbon dioxide, an organic gas, or a combination thereof.

In an aspect, the acid in the CGAA composition is used at a concentration of from about 1% to about 37% hydrochloric acid or equivalent hydrochloric acid concentration, in the case of hydrochloric acid donating or releasing organic or inorganic salts or adducts of hydrochloric acid, such as from about 7.5% to about 28% hydrochloric acid or equivalent hydrochloric acid concentration, such as about 15% hydrochloric acid or equivalent hydrochloric acid concentration.

In an aspect, the acidizing fluid further comprises an acid corrosion inhibitor or acid cleaning additive, such as iron-control additives, anti-sludge additives, surface tension reduction additives, mutual solvents, non-emulsifying additives, visco-elastic surfactant additives, solvents and solvent emulsifying additives, or combinations thereof.

In an aspect, the acid corrosion inhibitor comprises propargyl alcohol, amines, alkylamines, ethoxylated amines, cinnamaldehyde, or combinations thereof.

In an aspect, the colloidal gas aphrons comprise an average diameter of up to about 200 μm, such as from about 25 μm to about 200 μm.

In an aspect, the method comprises preparing the CGAA by mixing a surfactant, a fluid, and a gas to create a mixture, generating colloidal gas aphrons in the mixture, and adding acid.

In an aspect, the method comprises preparing the CGAA by adding colloidal gas aphrons to a mixture of a surfactant, a fluid, a gas, and an acid.

In an aspect, the acid is mixed with the surfactant, the fluid, and the gas prior to generating or adding the colloidal gas aphrons.

In an aspect, the acid is mixed with the surfactant, the fluid, and the gas after generating or adding the colloidal gas aphrons.

In an aspect, the fluid is a water-based fluid.

In an aspect, the fluid is water or brine.

In an aspect, the colloidal gas aphrons are made by application of shear force.

In an aspect, shear force is applied by a venturi tube, high shear gas sparging, homogenization, or a combination thereof.

In an aspect, the colloidal gas aphrons are made by application of a gas-containing or gas-generating compound.

In an aspect, the method is carried out downhole.

In an aspect, the method is carried out at the surface.

In an aspect, the colloidal gas aphrons are injected into the fluid at the surface or downhole.

In an aspect, the colloidal gas aphrons are generated in situ at the surface or downhole.

In an aspect, method comprises performing a perforation operation that underbalanced.

In an aspect, method comprises performing a perforation operation that is overbalanced.

In accordance with an aspect, there is provided a method of making the acidizing fluid described herein, the method comprising mixing a surfactant, a fluid, and a gas, generating colloidal gas aphrons in the mixture, and adding acid.

In accordance with an aspect, there is provided a method of making the acidizing fluid described herein, the method comprising adding colloidal gas aphrons to a mixture of a surfactant, a fluid, a gas, and an acid.

In an aspect, the acid is mixed with the surfactant and the fluid prior to generating or adding the colloidal gas aphrons.

In an aspect, the acid is mixed with the surfactant and the fluid after generating or adding the colloidal gas aphrons.

In an aspect, the fluid is a water-based fluid.

In an aspect, the fluid is water or brine.

In an aspect, the colloidal gas aphrons are made by application of shear force.

In an aspect, shear force is applied by a venturi tube, high shear gas sparging, homogenization, or a combination thereof.

In an aspect, the colloidal gas aphrons are made by application of a gas-containing or gas-generating compound.

In an aspect, the method is carried out downhole.

In an aspect, the method is carried out at the surface.

In an aspect, the colloidal gas aphrons are injected into the fluid at the surface or downhole.

In an aspect, the colloidal gas aphrons are generated in situ at the surface or downhole.

Other features and advantages of the present invention will become apparent from the following detailed description. It should be understood, however, that the detailed description and the specific examples while indicating embodiments of the invention are given by way of illustration only, since various changes and modifications within the spirit and scope of the invention will become apparent to those skilled in the art from said detailed description.

### DETAILED DESCRIPTION

In the oil and gas industry, there are three major types of acid applications: matrix acidizing, fracture acidizing, and breakdown or spearhead acidizing, which is pumped prior to a fracturing pad or other operation in order to assist with formation breakdown (reduce fracture pressures, decrease injection rate pressures), as well as clean up cement in the well bore or perforations after the perforation process is completed.

A matrix acid treatment is performed when acid is pumped into the well and into the pores of the reservoir formation below the fracture pressure. In this form of acidization, the acids dissolve the sediments formation and/or mud solids that are inhibiting the permeability of the rock, enlarging the natural pores of the reservoir (wormholing) and stimulating the flow of hydrocarbons to the wellbore for recovery. Typically, increase in permeability is affected primarily by the chemical reaction of the acid within the formation with little or no permeability increase being due to mechanical disruptions within the formation as in fracturing.

While matrix acidizing is done at a low enough pressure to avoid fracturing the reservoir rock, fracture acidizing involves pumping acid into the well at an extremely high pressure, physically fracturing the reservoir rock and etching the permeability inhibitive sediments. Typically, the practice in fracture acidizing is to dispose the acidizing fluid within the well opposite the formation to be fractured. This type of acid treatment forms channels or fractures through which the hydrocarbons can flow, in addition to forming a series of wormholes. Typically, the acid functions to dissolve formation materials forming the walls of the fracture, thus increasing the width and permeability thereof.

In some instances, a proppant is introduced into the fluid which assists in propping open the fractures, further enhancing the flow of hydrocarbons into the wellbore. There are many different mineral and organic acids used to perform an acid treatment on wells. The most common type of acid employed on wells to stimulate production is hydrochloric acid (HCl), which is useful in stimulating carbonate reservoirs, such as, for example, dolomites, limestones, and the like. As the reservoir rock should be at least partially soluble to the acidizing fluid so that channels can be etched in the fracture walls, stimulation of carbonate reservoirs, as opposed to stimulation of sandstone reservoirs, shale reservoirs or coat-seam reservoirs, is the typical use of the acidizing fluids described herein.

A limitation encountered in the acidizing of carbonate-based formations, however, is the rapid reaction rate of the acid, especially strong inorganic acids like hydrochloric acid, with those portions of the formation with which it first comes into contact. In typical examples, as the acidizing fluid is forced from the well into the formation, the acid reacts rapidly with the carbonate material immediately adjacent to the well. In this way, the acid becomes spent before it penetrates the formation a significant distance from the well. Typically, in respect of matrix acidizing of a limestone formation, a maximum penetration with a live acid to a depth of only a few inches to a foot from the face of the wellbore is achieved such that productivity or injectivity of the well can be greatly impacted. The problem is exacerbated in extended reach horizontal wells since live acids are usually spent within a few percentages of the total horizontal extension of the well.

In view of the foregoing, a number of attempts have been made to increase the penetration depth of acid. These include, for example, U.S. Pat. No. 3,233,672, the contents of which are incorporated herein by reference, to add a reaction inhibitor, such as alkyl-substituted carboximides and alkyl-substituted sulfoxides to the acidizing fluid. In another example provided by U.S. Pat. No. 3,076,762, the contents of which are incorporated herein by reference, solid, liquid, or gaseous carbon dioxide is introduced into the formation in conjunction with the acidizing solution. The carbon dioxide acts as a coolant, thus retarding the reaction rate of the acid with the formation carbonates. The carbon dioxide is said to become solubilized in the acidizing solution, thus resulting in the production of carbonic acid which changes the equilibrium point of the acid-carbonate reaction to accomplish a retarding effect.

Other attempts to control reaction rate include, for example, the formation of organic salts that can donate acid upon deployment, however, the strength of the acid is typically comprised and/or there are undesirable side reactions with the use of this method.

Attempts to control the rate of reaction of the acid without reducing its strength, in matrix and fracture acidizing procedures have also been attempted. For example, emulsified acids have been used to control the reaction rate through contact surface modifications. Typically, emulsified acids give reduced or retarded acid reaction rates because of the oil-external outer phase. Since reduced reaction rate generally means deeper and narrower wormholes that may include secondary microfractures, stable emulsion deposits in these longer wormholes/secondary microfractures require specific emulsion breaking and cleanup procedures/treatment, thereby limiting the usefulness of emulsified acids in these applications. Moreover, a number of acid diverting agents, such as oil-soluble naphthalene particles, some carboxylic acids, and viscoelastic surfactants (see, U.S. Pat. No. 6,399,546, the contents of which are incorporated herein by reference) have been utilized in acid stimulation. However, when acid reacts in carbonates and creates wormholes, the continued exposure to acid causes the wormhole fill with increased amounts of acid. In order to get the acid to a desired location, the wormhole is typically plugged. Unfortunately, use of a diverting agent may damage the wormhole causing a decrease in subsequent oil or gas production.

Thus, and as further described herein, the acidizing fluids described herein provide an alternative to aforementioned options that allows for, for example, reduced rapidly spent acid (e.g. retardation of the reaction rate between the acid in the CGAA composition and the hydrocarbon-bearing formation), increased penetration of the acid into the formation, increased wormhole formation through increased breakdown for the formation, all leading to increased permeability of the formation which can result in increased productivity of the well (e.g. hydrocarbon flow to the well for recovery).

Typically, fracking or stimulating a well will improve the production substantially and a well can be fracked or stimulated multiple times during its production life cycle. There are technical variations of a multistage fracturing technique.

A widely practiced variation is the so-called plug-and-perf fracturing method. It involves using wireline cable to run in the well with a frac plug for temporarily sealing off previously treated intervals and multiple select-fire perforating guns for creating multiple new fracture-initiation intervals known as perforation clusters. This method results in perforation and successful opening of conduits for fracturing fluid.

In a typical plug-and-perf operation, after a cemented liner or casing is in place, one must pump an isolation plug and perforating guns to a desired depth and location. The plug is set slightly beyond the desired location to be stimulated based on the well configuration, and then the casing in that area is perforated allowing access from the wellbore to the formation of interest, creating a path for fluid to be introduced into the formation.

The next stage prior to stimulation typically uses perforating guns, typically a bottom hole assembly (BHA) with shaped charges moved to a predetermined location within the wellbore. Once in position, the perforating gun is discharged which perforates the casing and initiates a path for the stimulation fluid to reach the formation.

Typically, after perforation and before a fracturing job, a spearhead acid is pumped downhole and circulated to clean up the perforation debris, thereby decreasing perforation friction pressure. This usually means displacement of an entire wellbore holdup of water per stage. Since in many cases the number of stages reaches or surpasses 100, this water usage and displacement time can incur unnecessary environmental and financial cost.

One way to avoid incurring these costs is to initiate the perforation while the acid is in place. A major reason why this procedure was generally avoided was the sub-optimal efficiency of acid corrosion inhibitors in the operation that involved explosion and high spot temperatures. The shield offered by the corrosion inhibitors, while adequate in steady state operations, failed to protect the valuable tools and wires in the heterogeneity induced by the explosion and subsequent melting of casing and destruction of cement at the perforating points of shaped charges.

Thus, in one aspect, use of the fluids described herein comprising a colloidal gas aphron-containing acid (CGAA), enable the operator to perform the operation and perforate with the perforating gun in the CGAA, with reliable protection of equipment optionally through multiple layers of inhibitor and aphrons.

While the introduction of gas into the well or fracturing operation in one form or another is not a new concept, there is a remarkable difference in the means and application of gases being introduced.

For example, U.S. Pat. No. 5,131,472 proposes a method for injecting gas into a well until the pressure in the liquid opposite the formation to be treated will be at least as large as the fracturing pressure of the formation when the liquid pressure is applied to the formation. In this method, the pressurising gas is applied to perform overbalanced perforation operation.

While in the early days of perforation practice, the operation used to be performed at pressures much higher than the reservoir pressure and up to the fracture pressure of the formation as suggested by U.S. Pat. No. 5,131,472, the problem usually encountered was that the debris from perforation were pushed into the formation at the point of perforation thereby covering the perforated hole surface with a layer of metal and other debris causing sometimes irreparable formation damage leading to low production and marginal operation economy.

A relatively recent improvement in perforation technology is underbalanced perforation. In this method, perforation is performed at pressures which are lower than the reservoir pressure. Ideally, this lower pressure conduit opened through perforation would cause the reservoir fluid to push the debris out of the newly created perforation. While this alteration has proven its worth in the field though higher comparable production rates and thereby economy of operation, the practical improvements proved to be less than the theoretical presentations. One reason for the deviation is that the perforating explosion is far from a steady state operation. Acids are used to clean the debris prior to fracturing but their efficiency is limited by practical mass transfer rate.

As described herein, the application of gas aphrons in the acidizing fluid has been found to increase the mass transfer rate and cleaning efficiency as a new concept that combines the reactivity of acid with the gas mobility of aphrons and decreases the time required for cleaning and initiation of fracturing.

In addition, the CGAAs described herein, depending on different physical and chemical properties, such as, for example, their size, the particular gas contained therein and/or the surfactant used can be useful in controlling the reaction rate of the acid in the acidizing fluid described herein. Since less acid is rapidly spent on contact with the hydrocarbon-bearing formation, this can allow the acid to penetrate deeper into the formation and propagate longer to create, larger and deeper acid wormholes. Accordingly, as the permeability of the formation increases, increased flow of hydrocarbons to the wellbore can occur, leading to increased efficiency and productivity of the well for hydrocarbon recovery.

The presence of colloidal gas aphrons can accelerate the interaction of acid and its penetration rate due to the enhanced mass transfer rate offered by aphrons and their eventual cavitation effect, which subsequently offers a superior flow-path compared to simple acids, acid blends or acid generating compounds. Colloidal gas aphrons can also improve the efficiency of acid inhibitors and assist in the protection of metals while simultaneously increasing the rock/formation breakdown efficiency of the acid since the acid is not rapidly spent upon application of the colloidal gas aphron containing acid composition to the formation.

Thus in aspects, described herein are methods and compositions for increasing the efficiency of acids used for matrix acidizing and/or fracture acidizing by injecting (or introducing) colloidal gas aphrons to the acid and placing the same acid in the hole before the perforation operation and keeping the same acid there while the operation is ongoing.

### DEFINITIONS

In understanding the scope of the present application, the articles “a”, “an”, “the”, and “said” are intended to mean that there are one or more of the elements. Additionally, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives.

It will be understood that any aspects described as “comprising” certain components may also “consist of” or “consist essentially of,” (or vice versa) wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effects described herein. For example, a composition defined using the phrase “consisting essentially of” encompasses any known pharmaceutically acceptable additive, excipient, diluent, carrier, and the like. Typically, a composition consisting essentially of a set of components will comprise less than 5% by weight, typically less than 3% by weight, more typically less than 1% by weight of non-specified components.

It will be understood that any component defined herein as being included may be explicitly excluded by way of proviso or negative limitation, such as any specific compounds or method steps, whether implicitly or explicitly defined herein.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

### Compositions and Methods

In aspects, an acidizing fluid is described herein. The acidizing fluid comprises a colloidal gas aphron-containing acid (CGAA) composition. In other words, the acidizing fluid comprises an acid that contains colloidal gas aphrons.

The book by Felix Sebba entitled “Foams and Biliquid Foams—Aphrons”, John Wiley & Sons, 1987, incorporated herein by reference, is an excellent source on the preparation and properties of aphrons. An aphron is made up of a core which is often spherical of an internal phase, usually gas, encapsulated in a thin shell. This shell contains surfactant molecules so positioned that they produce an effective barrier against coalescence with adjacent aphrons.

Colloidal gas aphrons are an interesting system which challenges conventional understanding and theories of foam physics. The most peculiar characteristic of this class of bubbles is their extraordinary longevity, having been reported to last for days, weeks, and months under ordinary conditions. Under downhole conditions, this time will be reduced such that colloidal gas aphrons described herein stabilized through surfactants described herein can offer rate limiting advantage through surface area modification without the drawback of other solutions, such as emulsions, since the colloidal gas aphrons can dissolve or burst in a relatively short time in downhole condition. This would mean, for example, further cleanup procedures are not required with the use of the CGAA compositions described herein. Therefore, the CGAs described herein can allow for control of the reaction rate of acid in a uniform, low cost and non-damaging method.

In typical aspects, the acidizing fluid is capable of controlling a reaction rate between the acid in the colloidal gas aphron-containing acid (CGAA) composition and a hydrocarbon-bearing formation. Typically, the reaction rate is reduced. In other words, the reaction rate is retarded or the reaction rate is slowed down, when comparing the reaction rate of the acid in the acidizing fluid described herein to an acidizing fluid that does not contain the CGA described herein. For example, the reduction in the rate of the reaction can be measured by a reduction in the change in weight of a sample of the hydrocarbon-bearing formation, such a carbonate formation like limestone, which is subjected to (e.g. reacted with) the acidizing fluid described herein or which is subjected to (e.g. reacted with) an acidizing fluid that does not contain the CGA described herein.

Typically the weight loss of the hydrocarbon-bearing formation sample is less than about 10% of the original weight of the hydrocarbon-bearing formation sample, when the acidizing fluid comprising the CGA is applied to the hydrocarbon-bearing formation sample. Thus the weight loss of hydrocarbon-bearing formation sample can be, for example, less than about 10%, or less than about 9%, or less than about 8%, or less than about 7%, or less than about 6%, or less than about 5%, or less than about 4%, or less than about 3%, or less than about 2%, or less than about 1% or less than about 0.5%, or less than about 0.1%, or less than about 0.05% or less than about 0.01% of the original hydrocarbon-bearing formation sample weight. Typically, the weight loss is less than 5%, more typically less than 3%. Accordingly, in typical aspects, the weight loss is about 0.01% to about 3%, such as about 0.01%, or 0.05%, or about 0.1%, or about 0.5%, or about 1%, or about 1.5%, or about 2%, or about 2.5%, to about 0.05%, or about 0.1%, or about 0.5%, or about 1%, or about 1.5%, or about 2%, or about 2.5% or about 3% of the weight of the original hydrocarbon-bearing formation sample. In this way, the hydrocarbon-bearing formation loses less of its original weight when the sample reacts with the acid of the acidizing fluid described herein. Moreover, the difference between the weight loss obtained by the acidizing fluid described herein and the acidizing fluid that does not contain the CGA described herein can be greater than about 3%, or greater than 4%, or greater than about 5%, or greater than about 6%, or greater than about 7%, or greater than about 8%, or greater than about 9%, or greater than about 10%.

Typically, the rate of the reaction is reduced such that, when the acidizing fluid is applied to the hydrocarbon-bearing formation, the acid is able to penetrate deeper into the formation as compared to an acidizing fluid that does not contain the colloidal gas aphron-containing acid (CGAA) composition. In this way, the acid of the acidizing fluids described herein is not rapidly spent/consumed when applied to the hydrocarbon-bearing formation (as compared to the acidizing fluid that does not contain the CGA described herein).

In this way, for example, as the acid is not rapidly spent upon contact with the formation, increased time between the colloidal gas aphron-containing acid (CGAA) composition and the hydrocarbon-bearing formation allows for further mechanical disruptions within the formation allowing for increased permeability thereof. In other words, the retardation of the reaction between the acid in the CGAA composition and the hydrocarbon-bearing formation (e.g. the carbonate formations described herein) can prevent the acid from being consumed in the first few meters of the well. In this way, the acidizing fluids described herein would be available for mid- and/or end-sections of the horizontal leg. This can ultimately lead to an increase in oil well productivity.

In typical aspects, the acidizing fluid described herein is for placement at or above a perforation area. In aspects, the acidizing fluid described herein is for matrix acidizing. In other aspects, the acidizing fluid described herein is for fracture acidizing. In this way, the CGA described herein can be added to the acid described herein to produce the acidizing fluid for matrix acidizing and/or fracture acidizing.

It will be understood that the acidizing fluid is for use before, during, and/or after a step of perforating a wellbore in a hydrocarbon-bearing formation, such as before the perforating step, during the perforating step, after the perforating step, before and during the perforating step, before and after the perforating step, during and after the perforating step, or before, during, and after the perforating step. In some aspects, the fluid is specifically for use before and/or during the perforating step, meaning that colloidal gas aphrons, and thus gas, is introduced into the wellbore before and/or during the perforating step. In typical aspects, the hydrocarbon-bearing formation is a carbonate-based formation. The carbonate-based formation can be, for example, dolomite, limestone, and the like.

There are at least three aspects associated with the stability of colloidal gas aphrons, which are advantageous for their uses as described herein: they have a negligible buoyancy force, which prevents them from rising to the free surface, their movement being solely dominated by Brownian motion; they have colloidal stability; and they have interfacial stability against dissolution.

Without wishing to be bound by theory, it is believed that the stability of nano and micro-entities depends on the strength of their surface charges. Thus, it would seem plausible that the surface charge might govern the stability of colloidal gas aphrons, and there is mounting evidence in support of such an argument.

Colloidal gas aphrons retain the same charge as the surfactant solution from which they are generated. They were first produced by stirring an aqueous surfactant solution contained in a fully baffled beaker via a spinning disk driven at high speed (6000 rpm) by an electric motor. Later, they were produced by various other methods such as dispersed air flotation, homogenization, sonication, electroflotation and chemical reaction.

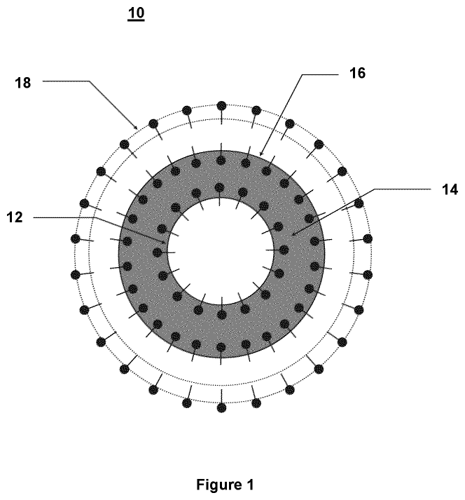

Surface structure and shell thickness of colloidal gas aphrons and regular foams differ in terms of bubble morphology. Sebba speculated that in colloidal gas aphrons, the bubbles were encapsulated in a multilayered shell consisting of a surfactant and liquid. However, colloidal gas aphron microfoams were found to consist of gas bubbles covered by a monolayer of surfactant molecules immersed in the solution containing micelles with repulsion among likely charged surfaces of microbubbles preventing their coalescence. FIG. 1 shows the typical shape of colloidal gas aphrons 10 in solution, wherein the colloidal gas aphrons 10 comprise a gas core 12 surrounded by a liquid shell 14 comprising surfactant molecules 16 in a surrounding solution 18.

Thus it can be seen that the introduction (injection) of colloidal gas aphrons into the fluid in contact with the perforating assembly and designated as matrix and/or fracture acidizing fluids offers considerable advantages over the conventional fluids.

The acidizing fluid described herein comprising a CGAA comprises an acid. Any acid is contemplated, for example the acid may comprise a mineral acid, an organic acid, a modified acid, a synthetic acid, or a combination thereof. Most oil field acids are water-based solutions of acidic molecules, e.g. hydrogen chloride, which is a gas is dissolved in water and applied mostly as 7.5-28% hydrochloric acid equivalent. With the application of surfactants, colloidal gas aphrons can be generated in these acidic solutions. While various concentrations of hydrochloric acid are typically used in the industry due mainly to its low cost and high water solubility of its salts and its acid strength, other acids or acid releasing materials including but not limited to HCl, methanesulphonic acid, toluenesulfonic acid, sulfamic acid, HCl:amino acid (including, for example, lysine, lysine monohydrochloride, alanine, asparagine, aspartic acid, cysteine, glutamic acid, histidine, leucine, methionine, proline, serine, threonine, valine, or combinations thereof), HCl:alkanolamine (including, for example, monoethanolamine, diethanolamine, triethanolamine, or combinations thereof), or combinations thereof are contemplated.

The acid in the CGAA composition is for use at any suitable concentration. Typically, the acid is used at a concentration of from about 1% to about 37% hydrochloric acid or equivalent hydrochloric acid concentration, in the case of hydrochloric acid donating or releasing organic or inorganic salts or adducts of hydrochloric acid, such as from about 7.5% to about 28% hydrochloric acid or equivalent hydrochloric acid concentration, such as about 15% hydrochloric acid or equivalent hydrochloric acid concentration.

The acidizing fluid described herein comprising a CGAA also comprises a surfactant. Any surfactant capable of generating aphrons and compatible with the acid and its optional inhibitor or inhibitor package can be used. For example, the surfactant typically comprises a non-ionic surfactant, an amphoteric surfactant, a cationic surfactant, an anionic surfactants, a polymeric surfactant, or combinations thereof.

More specific examples of surfactants for use herein include polyalkylene glycol, alcohol ethoxylate, betain, sulfonate, cetyltriammonium chloride or bromide, benzalkonium chloride or bromide, cetrimonium chloride or bromide, diphenyloxide disulfonic acid, lauryl ether sulfates, fatty alcohol ethoxylate, alkylphenol ethoxylate, ethoxylated nonylphenol, ethoxylated octylphenol, cocamidopropyl betain, cocoamidopropyl hydroxysultaine, a Gemini anionic surfactant, or combinations thereof. For example, alcohol ethoxylates, sulaines and Betains, sulfonates and quaternary ammonium based cationic surfactants may be used.

The acidizing fluid described herein comprising a CGAA also comprises a gas. Any gas can be used, for example, air, oxygen, argon, nitrogen, carbon dioxide, an organic gas, or combinations thereof. In this way, inert gases or highly reactive gases may be used in the acidizing fluids described herein.

The acidizing fluid described herein may further comprise additives, including inhibitors. For example, the acidizing fluid in aspects comprises an acid corrosion inhibitor or acid cleaning additive, such as an iron-control additive, an anti-sludge additive, a surface tension reduction additive, a mutual solvent, a non-emulsifying additive, a visco-elastic surfactant additive, a solvent, a solvent emulsifying additive, or combinations thereof.

While acids are excellent solubilizers and cleaning agents for the scales and debris, they also attack metals and since almost all the tubulars and downhole assemblies including wireline and perforating guns are of metallic alloys and susceptible to acid attack, most acids require some sort of reaction inhibition mechanism against metals. Inhibitors have been used over the past decades to protect these tubulars while performing acid stimulation and cleaning. Thus, in typical aspects, the acidizing fluid described herein further comprises a corrosion inhibitor adapted to prevent damaging corrosion to a tool, wire-line, and casing during a period of exposure with said fluid. Any tool typically used during a fracking or stimulation method is contemplated. In typical examples, the tool is a perforating gun.

Depending on the gas composition of the colloidal gas aphrons, they can offer a certain degree of protection to the metallic surfaces but still, they cannot typically fully replace inhibitors and the application of inhibitors is thus generally a necessary part of acid cleaning and stimulation procedures and formulations. Any commercially available acid corrosion inhibitor compatible with the surfactant or surfactants used in colloidal gas aphron generation can be used in the CGAA described herein. These include but are not limited to amines and amine derivative-type corrosion inhibitors, aldehyde and aldehyde derivative-type, amine-aldehyde-type reaction products, propargyl alcohol and its derivatives and other compounds or blends known to be effective in inhibiting the acid reaction with metals. For example, the acid corrosion inhibitor typically comprises propargyl alcohol, amines, alkylamines, ethoxylated amines, cinnamaldehyde, or combinations thereof.

Accordingly, the volumetric quantity of CGAs, their size, their gas content and the surfactant used to stabilize the CGA may play a role in the reactivity of acid towards the metals and the scale/debris.

The colloidal gas aphrons when first generated cover a wide size distribution ranging up to about 200 μm in diameter. At atmospheric pressure, the aphrons of exceedingly small diameter diminish fairly rapidly leaving aphrons in the 25 μm to about 200 μm size range. This is due to the excess pressure within the aphrons which increases as the diameter of the aphrons decreases. Thus, the smaller aphrons will tend to diminish in size by transferring their gas to the larger ones which would have a lower excess pressure. Thus, the colloidal gas aphrons in the CGAA typically comprise an average diameter of up to about 200 μm, such as from about 25 μm to about 200 μm.

The colloidal gas aphrons may be present in the acidizing fluid described herein in any amount. Typically, the acidizing fluid comprises from about 0.001% to about 50% by volume colloidal gas aphrons (CGAs), such as from about 0.01% to about 10% by volume CGAs, such as less than about 10% by volume CGAs, such as less than about 1% by volume CGAs, such as from about 0.01% to about 30% by volume CGAs, such as from about 0.1% to about 10% by volume CGAs, such as from about 0.5% to about 5% by volume CGAs.

The acidizing fluids described herein are in aspects for use in a perforation operation. It will be understood that the perforation operation is, in aspects, underbalanced or overbalanced and, typically, underbalanced.

As described in more detail below, the colloidal gas aphrons may be generated by any method. In aspects, they are generated at the surface through chemical reactions, downhole through chemical reactions, and/or downhole through gas injection.

The colloidal gas aphrons can be generated by means known in the art. In addition to the methods disclosed by Felix Sebba in his book referenced previously, methods are disclosed in Michelsen et al. U.S. Pat. No. 5,314,644, incorporated herein by reference, Yoon et al. U.S. Pat. No. 5,397,001, incorporated herein by reference, Kolaini U.S. Pat. No. 5,783,118, incorporated hereby by reference, Wheatley et al. U.S. Pat. No. 5,352,436, incorporated herein by reference, and U.S. Pat. Nos. 4,162,970; 4,112,025; 4,717,515; 4,304,740; and 3,671,022, each incorporated herein by reference.

For example, the colloidal gas aphrons can be created in the dilution water and transferred to the performance fluid or added to the wellbore water through air or other gases being injected together with suitable surfactants prior to acid introduction or can be generated within the acid at the surface through air or other gas injection together with the use of proper surfactants and equipment or chemically generated within the acid or water through decomposition of gas releasing compound or the whole process can be performed in-situ inside the well.

In the case of the CGAA described herein, the aphrons might be generated at atmospheric pressure at the surface through addition of surfactants and injection of gas or addition of gas generating components or they could be generated downhole through the same procedure. The aphrons generated downhole are typically smaller in size and more stable under pressure.

At the surface, the aphrons can be generated through addition of suitable surfactants to the acid and application of shear force. Any of the known methods of colloidal gas aphron generation can be used including but not limited to venturi tube, high shear gas sparging and homogenization. Most of these mechanical methods are most suitable for use at the surface or would require special assemblies to generate colloidal gas aphrons downhole.

Another method that can be applied at the surface or downhole is a chemical method. In this method, a gas containing or gas generating compound comes in contact with the acid, the gas is released or generated inside the interacting liquids and depending on the surfactant employed, the bubbles formed can be comminuted and dispersed into microbubbles. The amount of aphrons generated can be controlled by the amount of gas contained in the gas-containing liquid or gas generating component of the interacting liquid.

In other aspects, the CGAs described herein may be generated in-situ through gas generating chemical reactions or, alternatively, the CGAs can be generated externally and transferred to the acid described herein.

If desired, air or other gas can be incorporated into the fluid to entrain more gas for forming aphrons. The gas used may be any gas which is not appreciably soluble in the liquid phase of the fluid. Thus the gas may be air, nitrogen, carbon dioxide, organic gases, and the like.

In a typical aspect, the method allows for an operator to pump the tools down with the CGAA to perforate the zone in the vicinity of CGAA and allow the CGAA to contact the perforations or have the CGAA in place next to the perforations thus saving substantial time and water in each stage of the well. This is followed by the removal of the tool from the wellbore and initiating of the fracturing immediately.

Also described herein are various methods of use of the acidizing fluid. For example, provided herein is a method for increasing the penetration depth of an acid into a wellbore in a hydrocarbon-bearing formation, the method comprising applying the acidizing fluid described herein to the wellbore. In another example, provided herein is a method for simultaneously injecting gas and acid into a wellbore in a hydrocarbon-containing formation, the method comprising injecting the acidizing fluid described herein to the wellbore.

Also provided herein is a method for the fracking or stimulation of a hydrocarbon-bearing formation. The method comprises inserting a plug in a wellbore at a predetermined location, said wellbore in need of stimulation and comprising a casing; inserting a perforating tool and a matrix acidizing or fracture acidizing colloidal gas aphron-containing acidic (CGAA) composition into the wellbore; wherein said CGAA composition is in direct contact with both said tool and casing; positioning the tool within the CGAA composition near said predetermined location; perforating the wellbore with the tool thereby creating a perforated area and acid soluble debris; allowing the CGAA composition to come into contact with the perforated area and acid soluble debris for a predetermined period of time sufficient to prepare the formation for fracking or stimulation; controlling a rate of a reaction between the hydrocarbon-bearing formation and an acid in the colloidal gas aphron-containing acidic (CGAA) composition for a period of time; removing the tool from the wellbore; and initiating the fracking or stimulation of the perforated area using a stimulation fluid. In typical aspects, the CGAA composition further comprises a corrosion inhibitor adapted to prevent damaging corrosion to a tool, wire-line, and casing during a period of exposure with said fluid.

The methods described herein are also suitable for increasing acid penetration depth in a wellbore of a hydrocarbon-bearing formation in need of stimulation. In typical aspects, the reaction rate of the acid with the hydrocarbon-bearing formation is controlled such that the acid can penetrate further into the wellbore as compared to a matrix acidizing or fracture acidizing composition that does not contain the CGAA composition.

In typical aspects, controlling the rate of the reaction results in that the rate of the reaction is reduced. In other words, the reaction rate is retarded or the reaction rate is slowed down, when comparing the reaction rate of the acid in the acidizing fluid described herein to an acidizing fluid that does not contain the CGA described herein. Measuring the amount of reduction has been described above and is applicable to the description of the methods described herein. For example, as described above, the change in the amount of weight of the hydrocarbon-bearing sample can be used to assess the rate of reduction of the acid in the acidizing fluids described herein. In typical aspects, the change in weight of the hydrocarbon-bearing sample, such as the carbonate sample, wherein the weight loss of the carbonate sample is, for example between about 0.01% and about 10% of the original weight of the hydrocarbon-bearing sample. Therefore, the reaction that takes place between the acid of the acidizing fluid described herein and the hydrocarbon-bearing formation is slowed down since more of the hydrocarbon-bearing formation remains as compared to the acidizing fluid that does not contain the CGA described herein. In this way, the amount of the acid that is rapidly spent decreases such that there is more of the acid in the CGAA composition available to, for example, penetrate deeper into the wellbore. In addition, as the reduced reaction rate results in less acid being rapidly consumed upon reaction with the hydrocarbon-bearing formation, there is, for example, increased amount of acid available to continue to breakdown the formation (e.g. formation of larger and deeper wormholes) which can lead to, for example, increased permeability of the formation and therefore increased flow of hydrocarbons to the wellbore.

Also provided herein is an integrated method for perforating a casing and cleaning up debris inside a wellbore in need of stimulation, said method comprising the steps of: inserting a plug in a wellbore at a predetermined location, said wellbore in need of stimulation and comprising a casing; inserting a perforating tool and a matrix acidizing or fracture acidizing colloidal gas aphron-containing acidic (CGAA) composition into the wellbore; wherein said CGAA composition is in direct contact with both said tool and casing; positioning the tool within the CGAA composition near said predetermined location; perforating the wellbore with the tool thereby creating a perforated area on the casing and acid soluble debris; allowing the CGAA composition to come into contact with the perforated area and the acid soluble debris for a predetermined period of time sufficient to prepare the formation for fracking or stimulation; and removing the tool from the wellbore; wherein the CGAA composition comprises an acid and a corrosion inhibitor and is sufficiently balanced to dissolve the acid soluble debris within a time period which will leave the tool with acceptable corrosion damage from exposure to the CGAA composition.

In certain aspects, the method may include steps of preparing the CGAA. For example, in aspects, the method comprises preparing the CGAA by mixing a surfactant, a fluid, and a gas to create a mixture, generating colloidal gas aphrons in the mixture, and adding acid. In other aspects, the methods comprises preparing the CGAA by adding colloidal gas aphrons to a mixture of a surfactant, a fluid, a gas, and an acid.

The acid may be mixed with the surfactant, the fluid, and the gas prior to generating or adding the colloidal gas aphrons or the acid may be mixed with the surfactant, the fluid, and the gas after generating or adding the colloidal gas aphrons. The fluid described herein is typically a water-based fluid, such as water or brine.

As described above, the colloidal gas aphrons may be made by any method, for example by application of shear force and/or by application of a gas-containing or gas-generating compound. Shear force is typically applied by a venturi tube, high shear gas sparging, homogenization, or combinations thereof.

The method of making the colloidal gas aphrons and the resulting CGAA may be carried out downhole and/or at the surface. For example, in some aspects the colloidal gas aphrons are injected into the fluid at the surface or downhole. In some aspects, the colloidal gas aphrons are generated in situ at the surface or downhole.

It will be understood that the acidizing fluids and methods described herein can be used in perforation operation. The perforation operation, in aspects, is underbalanced. In other aspects, the perforation operation is overbalanced.

The above disclosure generally describes the present invention. A more complete understanding can be obtained by reference to the following specific Examples. These Examples are described solely for purposes of illustration and are not intended to limit the scope of the invention. Changes in form and substitution of equivalents are contemplated as circumstances may suggest or render expedient. Although specific terms have been employed herein, such terms are intended in a descriptive sense and not for purposes of limitation.

### EXAMPLES

### Example 1

While hydrochloric acid is the acid of choice in the oil field mainly due to its favorable cost-performance balance, it emits objectionable and hazardous odor, especially at higher strengths. There are more expensive hydrochloric acid releasing products in the market which are based on urea or amine hydrochlorides. To avoid those odors, urea hydrochloride was used in the following experiments at 15% equivalent hydrochloric acid concentration designated as 15% UHCL.

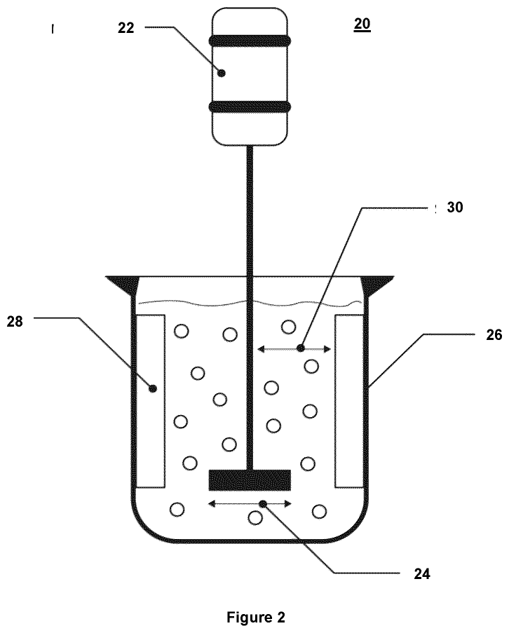

To produce CGAA, Anionic surfactant Calfax DBA-70 from Pilot chemical at 1% loading was added to the above-mentioned acid solution and aphrons were generated using a high-speed rotating disk generator 20 as shown in FIG. 2. Briefly, the high-speed rotating disk generator 20 comprises a mixer motor 22 that drives a rotating disk 24 inside a container 26 comprising a baffle 28 separated from the rotating disk 24 by a space 30.

### Test 1:

This test was done to investigate the effect of introduction of CGA into acid on the tubulars. The inhibitor and its concentration remained exactly the same but the test shows that the acid with CGA or the CGAA is the least corrosive towards metal coupons.

| | Initial | Final | Weight | |
|---|---|---|---|---|
| | weight | weight | loss | Percentage |
| Test duration: 6 hours | (gr) | (gr) | (gr) | loss (%) |
| 15% UHCL | 5.999 | 5.122 | 0.877 | 14.62 |
| 15% UHCL with Inhibitor | 5.739 | 5.714 | 0.025 | 0.44 |
| 15% UHCL with Inhibitor and | 6.015 | 6.003 | 0.012 | 0.20 |
| CGA | | | | |
| 15% UHCL with Inhibitor and | 6.148 | 6.107 | 0.041 | 0.66 |
| acrofoam | | | | |
| 15% UHCL with Macrofoam | 5.733 | 5.322 | 0.411 | 7.17 |

### Test 2:

This test was done to investigate the effect of introduction of CGA into acid, on hydrocarbon-bearing formations, in particular carbonate formations. In this example, the carbonate formation was limestone.

In this example, 300 ml of 15% UHCL was prepared as described above. A acidizing package including an iron control agent and a corrosion inhibitor was added. The sample was divided into two 150 ml portions. One portion was kept as a reference control and to the other portion, 0.1% of a surfactant was added and the mix was then subjected to sparging to ensure a 0.5 ml volume increase indicative of aphron generation.

Following aphron generation, limestone chips were dried, weighed and added to each of the two portions described above. After 15 minutes, the limestones were removed, washed, and weighed. The results of the test are shown in the table below:

| | Initial weight | Final weight | Weight loss |
|---|---|---|---|
| | (gr) | (gr) | (gr) |
| 15% UHCL | 14.91 | 13.64 | 1.27 |
| 15% UHCL with CGA | 14.58 | 14.26 | 0.32 |

As the results indicate, the reaction between the UHCL and the limestone in the portion with CGA shows retardation compared to the portion without the CGA as evidenced by the reduced amount of weight loss of the limestone in the CGA containing portion.

The above disclosure generally describes the present invention. Although specific terms have been employed herein, such terms are intended in a descriptive sense and not for purposes of limitation.

All publications, patents and patent applications cited above are herein incorporated by reference in their entirety to the same extent as if each individual publication, patent or patent application was specifically and individually indicated to be incorporated by reference in its entirety.

Although preferred embodiments of the invention have been described herein in detail, it will be understood by those skilled in the art that variations may be made thereto without departing from the spirit of the invention or the scope of the appended claims.

1. An acidizing fluid comprising a colloidal gas aphron-containing acid (CGAA) composition.

2. The acidizing fluid of claim 1, wherein the acidizing fluid is capable of controlling a reaction rate between the acid in the colloidal gas aphron-containing acid (CGAA) composition and a hydrocarbon-bearing formation.

3. The acidizing fluid of claim 2, wherein the rate of the reaction is reduced.

4. The acidizing fluid of claim 3, wherein the rate of the reaction is reduced such that, when the acidizing fluid is applied to the hydrocarbon-bearing formation, the acid is able to penetrate deeper into the formation as compared to an acidizing fluid that does not contain the colloidal gas aphron-containing acid (CGAA) composition.

5. The acidizing fluid of any one of claims 1 to 4, for placement at or above a perforation area.

6. The acidizing fluid of any one of claims 1 to 5, for use before, during, and/or after a step of perforating a wellbore in a hydrocarbon-bearing formation.

7. The acidizing fluid of any one of claims 1 to 6, for matrix acidizing or fracture acidizing.

8. The acidizing fluid of any one of claims 1 to 7, further comprising a corrosion inhibitor adapted to prevent damaging corrosion to a tool, wire-line, and casing during a period of exposure with said fluid.

9. The acidizing fluid of claim 8, wherein the tool is a perforating gun.

10. The acidizing fluid of any one of claims 1 to 9, wherein the acid comprises a mineral acid, an organic acid, a modified acid, a synthetic acid, or a combination thereof.

11. The acidizing fluid of claim 10, where the acid comprises HCl, methanesulphonic acid, toluenesulfonic acid, sulfamic acid, HCl:amino acid, HCl:alkanolamine, or a combination thereof.

12. The acidizing fluid of claim 11, wherein the amino acid comprises lysine, lysine monohydrochloride, alanine, asparagine, aspartic acid, cysteine, glutamic acid, histidine, leucine, methionine, proline, serine, threonine, valine, or a combination thereof.

13. The acidizing fluid of claim 11, wherein the alkanolamine comprises monoethanolamine, diethanolamine, triethanolamine, or a combination thereof.

14. The acidizing fluid of any one of claims 1 to 13, wherein the acidizing fluid comprises from about 0.001% to about 50% by volume colloidal gas aphrons (CGAs), such as from about 0.01% to about 10% by volume CGAs, such as less than about 10% by volume CGAs, such as less than about 1% by volume CGAs, such as from about 0.01% to about 30% by volume CGAs, such as from about 0.1% to about 10% by volume CGAs, such as from about 0.5% to about 5% by volume CGAs.

15. The acidizing fluid of any one of claims 1 to 14, wherein the CGAA composition further comprises a surfactant.

16. The acidizing fluid of claim 15, wherein the surfactant comprises a non-ionic surfactant, an amphoteric surfactant, a cationic surfactant, an anionic surfactants, a polymeric surfactant, or a combination thereof.

17. The acidizing fluid of claim 16, wherein the surfactant comprises polyalkylene glycol, alcohol ethoxylate, sulaine, betain, sulfonate, cetyltriammonium chloride or bromide, benzalkonium chloride or bromide, cetrimonium chloride or bromide, diphenyloxide disulfonic acid, lauryl ether sulfates, fatty alcohol ethoxylate, alkylphenol ethoxylate, ethoxylated nonylphenol, ethoxylated octylphenol, cocamidopropyl betain, cocoamidopropyl hydroxysultaine, or a combination thereof.

18. The acidizing fluid of claim 16, wherein the surfactant comprises a Gemini anionic surfactant.

19. The acidizing fluid of any one of claims 1 to 18, wherein the gas in the CGAA composition comprises air, oxygen, nitrogen, argon, carbon dioxide, an organic gas, or a combination thereof.

20. The acidizing fluid of any one of claims 1 to 19, wherein the acid in the CGAA composition is used at a concentration of from about 1% to about 37% hydrochloric acid or equivalent hydrochloric acid concentration, in the case of hydrochloric acid donating or releasing organic or inorganic salts or adducts of hydrochloric acid, such as from about 7.5% to about 28% hydrochloric acid or equivalent hydrochloric acid concentration, such as about 15% hydrochloric acid or equivalent hydrochloric acid concentration.

21. The acidizing fluid of any one of claims 1 to 20, further comprising an acid corrosion inhibitor or acid cleaning additive, such as iron-control additives, anti-sludge additives, surface tension reduction additives, mutual solvents, non-emulsifying additives, visco-elastic surfactant additives, solvents and solvent emulsifying additives, or combinations thereof.

22. The acidizing fluid of claim 21, wherein the acid corrosion inhibitor comprises propargyl alcohol, amines, alkylamines, ethoxylated amines, cinnamaldehyde, or combinations thereof.

23. The acidizing fluid of any one of claims 1 to 22, wherein the colloidal gas aphrons comprise an average diameter of up to about 200 μm, such as from about 25 μm to about 200 μm.

24. The acidizing fluid of any one of claims 1 to 23, for use in a perforation operation that is performed underbalanced.

25. The acidizing fluid of any one of claims 1 to 23, for use in a perforation operation that is performed overbalanced.

26. The acidizing fluid of any one of claims 1 to 25, wherein the colloidal gas aphrons are generated at the surface through chemical reactions.

27. The acidizing fluid of any one of claims 1 to 25, wherein the colloidal gas aphrons are generated downhole through chemical reactions.

28. The acidizing fluid of any one of claims 1 to 25, wherein the colloidal gas aphrons are generated downhole through gas injection.

29. A method for increasing the penetration depth of an acid into a wellbore in a hydrocarbon-bearing formation, the method comprising applying the fluid of any one of claims 1 to 28 to the wellbore.

30. A method for simultaneously injecting gas and acid into a wellbore in a hydrocarbon-containing formation, the method comprising injecting the fluid of any one of claims 1 to 28 to the wellbore.

31. A method for the fracking or stimulation of a hydrocarbon-bearing formation, the method comprising:
inserting a plug in a wellbore at a predetermined location, said wellbore in need of stimulation and comprising a casing;
inserting a perforating tool and a matrix acidizing or fracture acidizing colloidal gas aphron-containing acidic (CGAA) composition into the wellbore; wherein said CGAA composition is in direct contact with both said tool and casing;
positioning the tool within the CGAA composition near said predetermined location;
perforating the wellbore with the tool thereby creating a perforated area and acid soluble debris;
allowing the CGAA composition to come into contact with the perforated area and acid soluble debris for a predetermined period of time sufficient to prepare the formation for fracking or stimulation;
controlling a rate of a reaction between the hydrocarbon-bearing formation and an acid in the colloidal gas aphron-containing acidic (CGAA) composition for a period of time;
removing the tool from the wellbore; and
initiating the fracking or stimulation of the perforated area using a stimulation fluid.

32. The method of claim 31, wherein the CGAA composition further comprises a corrosion inhibitor adapted to prevent damaging corrosion to a tool, wire-line, and casing during a period of exposure with said fluid.

33. The method of claim 31 or 32, wherein the method is suitable for increasing acid penetration depth in the wellbore of the hydrocarbon-bearing formation in need of stimulation, wherein the reaction rate of the acid with the hydrocarbon-bearing formation is controlled such that the acid can penetrate further into the wellbore as compared to a matrix acidizing or fracture acidizing composition that does not contain the CGAA composition.

34. The method of any one of claims 31 to 33, wherein the reaction rate is reduced such that the acid is available to penetrate deeper into the wellbore.

35. The method of claim 34, wherein the acid causes increased breakdown and/or increased permeability of the hydrocarbon-bearing formation.

36. The method of any one of claims 31 to 35, wherein the step of applying the fluid to the wellbore is before, during, and/or after the step of perforating the wellbore.

37. The method of claim 36, wherein the step of applying the fluid to the wellbore is before and/or during the step of perforating the wellbore.

38. The method of any one of claims 31 to 37, wherein the tool is a perforating gun.

39. The method of any one of claims 31 to 38, wherein the acid comprises a mineral acid, an organic acid, a modified acid, a synthetic acid, or a combination thereof.

40. The method of claim 39, where the acid comprises HCl, methanesulphonic acid, toluenesulfonic acid, sulfamic acid, HCl:amino acid, HCl:alkanolamine, or a combination thereof.

41. The method of claim 40, wherein the amino acid comprises lysine, lysine monohydrochloride, alanine, asparagine, aspartic acid, cysteine, glutamic acid, histidine, leucine, methionine, proline, serine, threonine, valine, or a combination thereof.

42. The method of claim 40, wherein the alkanolamine comprises monoethanolamine, diethanolamine, triethanolamine, or a combination thereof.

43. The method of any one of claims 31 to 42, wherein the fluid comprises from about 0.001% to about 50% by volume colloidal gas aphrons (CGAs), such as from about 0.01% to about 10% by volume CGAs, such as less than about 10% by volume CGAs, such as less than about 1% by volume CGAs, such as from about 0.01% to about 30% by volume CGAs, such as from about 0.1% to about 10% by volume CGAs, such as from about 0.5% to about 5% by volume CGAs.

44. The method of any one of claims 31 to 43, wherein the CGAA composition further comprises a surfactant.

45. The method of claim 44, wherein the surfactant comprises a non-ionic surfactant, an amphoteric surfactant, a cationic surfactant, an anionic surfactants, a polymeric surfactant, or a combination thereof.

46. The method of claim 45, wherein the surfactant comprises polyalkylene glycol, alcohol ethoxylate, sulaine, betain, sulfonate, cetyltriammonium chloride or bromide, benzalkonium chloride or bromide, cetrimonium chloride or bromide, diphenyloxide disulfonic acid, lauryl ether sulfates, fatty alcohol ethoxylate, alkylphenol ethoxylate, ethoxylated nonylphenol, ethoxylated octylphenol, cocamidopropyl betain, cocoamidopropyl hydroxysultaine, or a combination thereof.

47. The method of claim 45, wherein the surfactant comprises a Gemini surfactant.

48. The method of any one of claims 31 to 47, wherein the gas in the CGAA composition comprises air, oxygen, nitrogen, argon, carbon dioxide, an organic gas, or a combination thereof.

49. The method of any one of claims 31 to 48, wherein the acid in the CGAA composition is used at a concentration of from about 1% to about 37% hydrochloric acid or equivalent hydrochloric acid concentration, in the case of hydrochloric acid donating or releasing organic or inorganic salts or adducts of hydrochloric acid, such as from about 7.5% to about 28% hydrochloric acid or equivalent hydrochloric acid concentration, such as about 15% hydrochloric acid or equivalent hydrochloric acid concentration.

50. The method of any one of claims 31 to 49, further comprising an acid corrosion inhibitor or acid cleaning additive, such as iron-control additives, anti-sludge additives, surface tension reduction additives, mutual solvents, non-emulsifying additives, visco-elastic surfactant additives, solvents and solvent emulsifying additives, or combinations thereof.

51. The method of claim 50, wherein the acid corrosion inhibitor comprises propargyl alcohol, amines, alkylamines, ethoxylated amines, cinnamaldehyde, or combinations thereof.

52. The method of any one of claims 31 to 51, wherein the colloidal gas aphrons comprise an average diameter of up to about 200 μm, such as from about 25 μm to about 200 μm.

53. The method of any one of claims 31 to 52, the method comprising preparing the CGAA by mixing a surfactant, a fluid, and a gas to create a mixture, generating colloidal gas aphrons in the mixture, and adding acid.

54. The method of any one of claims 31 to 53, the method comprising preparing the CGAA by adding colloidal gas aphrons to a mixture of a surfactant, a fluid, a gas, and an acid.

55. The method of claim 53 or 54, wherein the acid is mixed with the surfactant, the fluid, and the gas prior to generating or adding the colloidal gas aphrons.

56. The method of claim 53 or 54, wherein the acid is mixed with the surfactant, the fluid, and the gas after generating or adding the colloidal gas aphrons.

57. The method of any one of claims 53 to 56, wherein the fluid is a water-based fluid.

58. The method of claim 57, wherein the fluid is water or brine.

59. The method of any one of claims 53 to 58, wherein the colloidal gas aphrons are made by application of shear force.

60. The method of claim 59, wherein shear force is applied by a venturi tube, high shear gas sparging, homogenization, or a combination thereof.

61. The method of any one of claims 53 to 58, wherein the colloidal gas aphrons are made by application of a gas-containing or gas-generating compound.

62. The method of any one of claims 53 to 61, wherein the method is carried out downhole.

63. The method of any one of claims 53 to 61, wherein the method is carried out at the surface.

64. The method of any one of claims 53 to 61, wherein the colloidal gas aphrons are injected into the fluid at the surface or downhole.

65. The method of any one of claims 53 to 61, wherein the colloidal gas aphrons are generated in situ at the surface or downhole.

66. The method of any one of claims 53 to 65, comprising performing a perforation operation that underbalanced.

67. The method of any one of claims 53 to 65, comprising performing a perforation operation that is overbalanced.

68. A method of making the fluid of any one of claims 1 to 28, the method comprising mixing a surfactant, a fluid, and a gas, generating colloidal gas aphrons in the mixture, and adding acid.

69. A method of making the fluid of any one of claims 1 to 28, the method comprising adding colloidal gas aphrons to a mixture of a surfactant, a fluid, a gas, and an acid.

70. The method of claim 68 or 69, wherein the acid is mixed with the surfactant and the fluid prior to generating or adding the colloidal gas aphrons.

71. The method of claim 68 or 69, wherein the acid is mixed with the surfactant and the fluid after generating or adding the colloidal gas aphrons.

72. The method of any one of claims 68 to 63, wherein the fluid is a water-based fluid.

73. The method of claim 72, wherein the fluid is water or brine.

74. The method of any one of claims 68 to 73, wherein the colloidal gas aphrons are made by application of shear force.

75. The method of claim 74, wherein shear force is applied by a venturi tube, high shear gas sparging, homogenization, or a combination thereof.

76. The method of any one of claims 68 to 73, wherein the colloidal gas aphrons are made by application of a gas-containing or gas-generating compound.

77. The method of any one of claims 68 to 76, wherein the method is carried out downhole.

78. The method of any one of claims 68 to 76, wherein the method is carried out at the surface.

79. The method of any one of claims 68 to 76 wherein the colloidal gas aphrons are injected into the fluid at the surface or downhole.

80. The method of any one of claims 68 to 76, wherein the colloidal gas aphrons are generated in situ at the surface or downhole.
